(19) United States
(12) Patent Application Publication
(10) Pub. No.: US 2024/0345237 A1
(43) Pub. Date: Oct. 17, 2024

(54) Method and Localisation Device for Localising a Motor Vehicle, and Motor Vehicle

(71) Applicant: Bayerische Motoren Werke Aktiengesellschaft, Muenchen (DE)

(72) Inventors: Michael MANZ, Steinhoering (DE); Christian PANHUBER, Muenchen (DE)

(21) Appl. No.: 18/294,285

(22) PCT Filed: Aug. 16, 2022
(86) PCT No.: PCT/EP2022/072877

§ 371 Date: Feb. 1, 2024

(30) Foreign Application Priority Data
Aug. 18, 2021 (DE) 10 2021 121 406.8

(51) Int. Cl. G01S 13/10; G01C 21/30; G01S 5/02; G01S 13/52; G01S 13/931

(52) U.S. Cl. CPC G01S 13/10; G01C 21/30; G01S 5/0294; G01S 13/52; G01S 13/931; G01S 2013/93274

(57) ABSTRACT

Methods, systems, and apparatuses are provided for localizing a motor vehicle. A map is provided in which artificial side barriers that run laterally along a road are entered; emitting radar signals in a transverse direction of the vehicle during a journey using a radar device of the motor vehicle. Resulting radar echoes are received. The radar echoes which were reflected perpendicular to a longitudinal direction of the vehicle and/or perpendicular to the direction of travel of the motor vehicle are determined that indicate a vanishing relative velocity between the motor vehicle and a respective source from which the radar echo originates. A distance of the motor vehicle from the respective source is determined based on the radar echoes. The source of the radar echoes is identified as an artificial side barrier. Based on the identified source, a current position of the motor vehicle is determined in the map.

### BACKGROUND AND SUMMARY

The present subject matter relates to a method and a localization device for localizing a motor vehicle. The present subject matter also relates to a motor vehicle set up or equipped accordingly.

For many of the desired assistance functions or automated driving functions of motor vehicles, precise knowledge of the current position of the motor vehicle is an important basis. There are already various approaches to this, such as environment detection using cameras and automatic object recognition. However, cameras may be limited by unfavorable environmental conditions, such as nighttime, low sun or sunlight incident directly into the camera, fog, heavy rain, and/or the like.

In addition, accurately determining distances from camera images can be difficult or impossible. Suitable devices and/or algorithms for so-called computer vision can be comparatively computationally intensive and therefore not always practicable to operate or carry out with full precision in real time.

A specific approach for a method for localizing a vehicle in a high-definition map based on landmark objects using a sensor fusion module is described in DE 10 2018 008 904 A1. In it, a geoposition of the vehicle is determined, a potential landmark object is detected using an environment detection system in a vehicle coordinate system and is registered with at least one landmark object in the high definition map. From this, a more precise localization of the vehicle is determined compared to the geoposition. It is envisaged that a reference line arranged along a route of the motor vehicle will be determined and that the potential landmark object and the at least one landmark object will be projected onto the reference line and registered along the reference line. Ultimately, this will enable improved localization of a vehicle.

The object of the present subject matter is to enable particularly robust localization of a motor vehicle.

According to the present subject matter, this object is achieved by the subject-matter of the independent patent claims. Possible examples and developments of the present subject matter are disclosed in the dependent claims, in the description and in the FIGURE.

The method according to the present subject matter is used to localize a motor vehicle, in particular in or relative to a given map. The method according to the present subject matter includes multiple steps of the method, which can in particular be carried out automatically or semi-automatically, for example using a suitably set up localization device according to the present subject matter for localizing a motor vehicle. For the method, a predetermined map is provided in which artificial side barriers are entered or indicated, which run laterally next to and in the direction of travel along a road, i.e., at least substantially parallel to a road. Such artificial side barriers can be, for example, crash barriers, concrete barriers or concrete restraint systems, noise barriers, tunnel walls and/or the like. Such artificial side barriers can be unchangeable in their position and shape and thus fundamentally different, for example, from changing native vegetation at the edge of the road. According to the findings underlying the present subject matter, such artificial side barriers are therefore valuable reference objects that can enable accurate, reliable and robust vehicle localization.

In particular, the map provided may be a so-called HD (HD: High Definition) map, which may contain corresponding details, such as in particular the artificial side barriers, which are typically not present or entered in conventional maps. For example, the map or HD map may have a resolution or precision at centimeter level, for example, better than 1 m, better than 50 cm, or better than 20 cm.

In a step of the method according to the present subject matter, radar signals are emitted in the transverse direction of the vehicle during a journey using a radar device of the motor vehicle and corresponding or resulting radar echoes are received. The radar signals can therefore be emitted to at least one side, preferably to both sides, i.e., to the left and/or to the right relative to a forward direction of travel of the motor vehicle. Accordingly, the radar device may be a side radar of the motor vehicle.

A journey of the motor vehicle in the present sense may include, in particular, vehicle movements, but also traffic-related standstills of the motor vehicle, for example in a traffic jam situation or at a traffic light system or the like.

In a further step of the method according to the present subject matter, those of the received radar echoes are determined which have been reflected perpendicular to the longitudinal direction of the vehicle and/or perpendicular to the current direction of travel of the motor vehicle and which indicate a vanishing relative velocity between the motor vehicle or the radar device of the motor vehicle and a respective source from which the radar echo originates. In addition, based on this a distance is determined of the motor vehicle from the respective source, i.e., a respective object external to the vehicle from which the radar echo was generated or reflected. For this purpose, for example, a corresponding low-level processing or pre-processing of the received radar echoes can be carried out automatically, by means of which angles and distances, i.e., ultimately positions of the sources of the radar echoes, i.e., corresponding radar reflections relative to the radar device or the sensor thereof, can be determined. This can be carried out, for example, by the radar device itself or by a device coupled to it, such as the localization device according to the present subject matter or a corresponding data processing device. This can result in a list of radar echoes, which can then be further processed or, for example, transmitted to or recorded by the localization device according to the present subject matter.

The fact that the determined radar echoes indicate a vanishing relative velocity means that the radar echoes have properties or parameters that are consistent with a reflection from an object that is immobile, i.e., stationary, relative to the motor vehicle or radar device. This can concern, for example, a Doppler shift of the radar echoes. A predetermined tolerance interval around a relative velocity of 0 m/s can be considered or allowed, for example to consider unavoidable signal noise.

In the presence of an artificial side barrier in the detection region of the radar device, at least one or exactly one such a radar echo can occur in each measurement cycle of the radar device, i.e. it can be determined. However, a large number of measurement cycles of the radar device can be passed through during the journey of the vehicle, and accordingly multiple or many such radar echoes may occur or be determined.

In a further step of the method according to the present subject matter, the respective source of these determined radar echoes is identified as an artificial side barrier. Based on this, the current position of the motor vehicle in the map is then determined. At least a lateral position of the motor vehicle on the road can be determined, i.e., a lateral distance from the motor vehicle to the respective artificial side barrier in the transverse direction of the vehicle or perpendicular to the direction of travel or the longitudinal direction of the road.

In other words, the source of the determined radar echoes, which is recognized as an artificial side barrier on the basis of radar, is identified as, i.e., equated with, an artificial side barrier entered in the map.

A longitudinal position of the motor vehicle, i.e., the position of the motor vehicle in the longitudinal direction of the vehicle or in the direction of travel or the longitudinal direction of the road, may be determined or limited by other measures or methods, for example using a global navigation satellite system, by automatic detection of other features in the vicinity of the motor vehicle, and/or the like. In particular, this can be done before identifying the artificial side barrier in the map. In this way, it is possible to limit the position of the motor vehicle in order to limit a search area or potential area for the identification of the respective artificial side barriers in the map.

The present subject matter is based on the knowledge that artificial side barriers within the meaning of the present subject matter consistently produce radar echoes with the described properties, whereas this is not the case for other unstructured environment objects, such as vegetation along the roadside. Therefore, artificial side barriers can be identified on the basis of such radar echoes. As already indicated at the beginning, such artificial side barriers are suitable reference objects at least for lateral localization, i.e., the determination of the position of the motor vehicle. Since the artificial side barriers in the present sense retain their position and shape, they enable particularly robust and reliable localization of the motor vehicle. The fact that the location of the vehicle is radar-based here also contributes to improved robustness and reliability of the localization, for example compared to camera-based localization. This is the case because radar devices or radar signals, for example time-of-flight or Doppler-based, inherently enable a more accurate distance determination than camera images and are also independent of lighting conditions in the environment and are not influenced by weather phenomena, or at least are influenced to a lesser extent.

The method according to the present subject matter or the steps thereof may be carried out continuously or repeated regularly while the motor vehicle is in motion. This may apply or may be the case at least until the map is provided. This may be carried out or take place, for example, once at the beginning of each execution of the method, for example by loading the map into a computer-readable data memory, activating or making accessible such a data memory, or the like. By such a continuous or repeated performance of the method according to the present subject matter, at least the lateral position of the motor vehicle can be monitored appropriately during a journey.

In a possible example of the present subject matter, the respective source of the determined radar echoes is identified as an artificial side barrier only if a corresponding radar echo with the mentioned properties is detected from the same point in a coordinate system fixed to the vehicle over multiple, in particular sequential, measurement cycles of the radar device. In other words, in order for a source of radar echoes to be successfully identified as an artificial side barrier, the source must be detected or occur at the same point, i.e., in the same relative position to the motor vehicle, multiple times at a time interval from each other in a coordinate system owned by the vehicle or moving with the motor vehicle. This is consistent with the assumption that a longitudinal artificial side barrier is present or extends along the road travelled by the motor vehicle, especially when the motor vehicle is moving over the multiple measurement cycles of the radar device. It is not just that the radar signals are emitted exactly in the corresponding transverse direction of the vehicle in a single divergence-free beam bundle, further radar echoes can be received which are incident at different angles, i.e. not perpendicular to the longitudinal direction of the vehicle or to the direction of travel of the motor vehicle, and/or which indicate a relative velocity of the respective source to the motor vehicle that differs from 0 m/s. Although these radar echoes can also be consistent with an artificial side barrier, they typically do not occur consistently over multiple measurement cycles and may also originate from other objects in the vicinity of the motor vehicle, so that a robust and identification of an artificial side barrier as the source of the radar echoes is not reliably possible on the basis of these radar echoes. For example, such radar echoes can be caused once or randomly by vegetation, other objects of road equipment that do not extend longitudinally along the road, other road users and/or the like. The safety and reliability of the identification of the artificial side barrier can be improved by the proposed design of the present subject matter.

In a further possible example of the present subject matter, in particular when an artificial side barrier is or has been identified, an expected radar echo from the artificial side barrier, i.e., an expected measurement of the radar device in the presence of the artificial side barrier, is determined on the basis of the map provided. In particular, a current pose of the motor vehicle can be considered in order to determine the characteristics or parameters of the expected radar echoes. For this purpose, for example, a steering angle, a state of movement, a pose or partial pose of the motor vehicle determined or limited by other means, and/or the like, can be determined and considered. The position of the motor vehicle on the map is then monitored based on the expected radar echo and the determined radar echo(s). The expected radar echo can be determined based on the knowledge that a radar echo with predefined properties or parameters can only be expected for a point of an object in the vicinity of the motor vehicle or in the detection region of the radar device in which a surface of the object is parallel to the wavefront of the radar signals, i.e., a point where the emitted radar signal strikes the surface of the object perpendicularly. For example, a corresponding pair of an expected and an actual received radar echo can be used in a recursive Bayesian filter, such as a Kalman filter, or in a particle filter, or similar, to monitor the position of the motor vehicle in or relative to the map provided. Such monitoring of the position over a period of time may result in a trajectory of the motor vehicle. This makes it possible to monitor or plausibility check the localization, i.e., the specific position of the motor vehicle, since a real trajectory of a motor vehicle cannot continue or change from point to point in an arbitrary manner. Based on this, other useful functions can also be realized or implemented, such as trajectory or collision prediction, interventions in longitudinal and/or lateral guidance of the vehicle and/or the like.

In a further possible example of the present subject matter, a corresponding particle is generated for some or all of the received radar echoes in a predetermined model. A predefined particle filter is then applied in or on this to identify the radar echoes originating from the artificial side barrier. The particle filter allows the radar echoes to be monitored over time. In order to keep the computational effort low, for example, a corresponding particle can only be generated in the model for radar echoes that meet at least one given basic criterion. This basic criterion may correspond, for example, to the properties of the specific radar echo. In other words, a particle can only be generated for those radar echoes that are consistent with a relative velocity of at least substantially 0 m/s and/or a detection angle or an angle of incidence that can be explained by an object extending along the road parallel to the longitudinal direction of the road. The methodology proposed here represents a particularly simple and low-cost way to implement and carry out the robust and reliable identification of radar echoes generated or reflected back by an artificial side barrier located along the respective road.

In a possible development of the present subject matter, the particle filter retains from measurement cycle to measurement cycle of the radar device only those particles which are repeated, i.e. from measurement cycle to measurement cycle, at the same place or position in a coordinate system fixed to the vehicle, i.e. relative to the motor vehicle, in particular at a point expected for an artificial side barrier in the present sense, and which indicate a vanishing relative velocity of the respective source from which the associated radar echoes originate relative to the motor vehicle or relative to the radar device which is fixed to the vehicle. In other words, the retention or survival of the individual particles of a modeled particle population depends on whether the respective monitored radar echo repeats itself at the same position in a new measurement cycle and whether it indicates a relative velocity of the source of the respective radar echo of—at least approximately—0 m/s. Thus, the particle population will converge to a single point or particle corresponding to the source of a corresponding perpendicular radar reflection and corresponding to a point on an artificial side barrier, if such an artificial side barrier is present in the vicinity of the motor vehicle or in the detection region of the radar device. In the absence of such an artificial side barrier or a corresponding source of radar echoes, the particle population will not converge over multiple measurement cycles, i.e. over multiple applications of the particle filter, because all individual particles, which may originate from vegetation, an unstructured embankment or other individual objects, are filtered out again and again and replaced by other radar echoes or corresponding particles at random angles, at random intervals and/or with properties indicating different or random relative velocities. The proposed design of the present subject matter represents a possibility for a reliable and robust identification of artificial side barriers or radar echoes originating from such an artificial side barrier which can be implemented and used particularly simply and at low cost.

In a further possible example of the present subject matter, a change of a radar echo originating from an artificial side barrier during a lateral relative motion between the motor vehicle and the side barrier is modelled. This modelled change is then considered for the assignment of radar echoes over multiple measurement cycles of the radar device. Thus, in the event of such a lateral relative movement, for example, a radar echo can still be assigned to the side barrier or to previous radar echoes, i.e., radar echoes recorded in previous measurement cycles or to be expected or future instances of a radar echo originating from the side barrier. Thus, the lateral position of the motor vehicle relative to the artificial side barrier can then be determined and monitored consistently and reliably over periods or areas of relative movement. This can be particularly useful because in such situations, i.e., during a lateral relative movement between the motor vehicle and the side barrier, no radar echo with the mentioned characteristics may occur, i.e., the vertical direction of incidence and the relative velocity of at least almost 0 m/s, but by modelling and considering the change in a corresponding radar echo, position determination and position monitoring are still possible without interruption. By means of appropriate modelling, the lateral relative motion or the effect thereof on the corresponding radar echo can thus be compensated.

In a possible development of the present subject matter, odometry data of the motor vehicle are automatically evaluated for determining the lateral relative motion. For this purpose, the odometry data that can indicate, describe or characterize the intrinsic movement of the motor vehicle can be recorded, for example by the localization device, as well as, for example, data or signals indicating a steering movement or a steering angle, a lane change and/or the like. If necessary, in particular if it is possible to conclude from the data collected that the motor vehicle has changed lanes, it may, for example, be assumed that the artificial side barrier will continue to run parallel to the lane previously travelled on. This can enable a particularly simple determination of the lateral relative motion and a particularly simple determination of the corresponding change in the radar echo.

In a possible development of the present subject matter, a course of the road is determined for determining the lateral relative motion and a course of the side barrier following this course of the road is modelled or assumed. This may be the case in particular or may be considered if recorded odometry data and/or vehicle data indicating or characterizing the intrinsic movement of the vehicle are consistent with unchanged straight-line driving of the vehicle. For example, the relative lateral movement between the motor vehicle and the side barrier may be caused, in whole or in part, by the side barrier or its course following a widening of the road, emulating the beginning or end of a lane, enclosing or surrounding and/or similar an emergency stop bay or parking lot or the like. In such cases, the relative lateral movement may occur even in the absence of a transverse movement of the motor vehicle relative to a lane being travelled on. A corresponding course of the road can be determined, for example, on the basis of the map provided, by detecting the environment using an environmental sensor system of the motor vehicle and/or the like. The course of the road can also be modelled or smoothed in whole or in part on the assumption that corresponding road changes follow a polynomial or catenary curve. Such a course can then also be assumed or modelled for the side barrier. A corresponding model or a corresponding course or hypothesis can then be mapped or considered, for example, in the filter mentioned elsewhere by maintaining corresponding radar echoes or corresponding particles that are consistent therewith. In particular, corresponding deviations or changes in the model and/or through the filter may be weighted in a predetermined manner differently from radar echoes or particles occurring without lateral relative motion, in particular underweighted. This makes it possible to consider any greater uncertainty of localization in the case of lateral relative movement.

Another aspect of the present subject matter is a localization device, in particular for a motor vehicle, which has a data interface for acquiring radar data, a computer-readable data memory and a processor device coupled to it, such as a microchip, microcontroller or microprocessor or the like. The localization device according to the present subject matter is set up to carry out the method according to the present subject matter in at least one variant, example or development, in particular automatically or semi-automatically. For this purpose, for example, a corresponding operating program or computer program can be placed, i.e., stored, in the data memory, which codes or implements the corresponding method or the steps of the method and which can be executed by the processor device in order to effect or cause carrying out of the corresponding method. For example, the localization device may be set up to collect and process radar data in the form of raw signals or radar data pre-processed as described. In particular, the localization device may be or correspond to the localization device referred to in connection with the method according to the present subject matter. Accordingly, the localization device according to the present subject matter may have some or all of the properties and/or features mentioned in connection with the method according to the present subject matter.

A further aspect of the present subject matter is a motor vehicle which has at least one radar device which is oriented to detect environment objects to the side of the motor vehicle in the transverse direction of the vehicle. The motor vehicle according to the present subject matter also has a localization device according to the present subject matter coupled to it. The motor vehicle according to the present subject matter is therefore also set up for carrying out the method according to the present subject matter, in particular automatically or semi-automatically. In particular, the motor vehicle in question may be the motor vehicle referred to in connection with the method according to the present subject matter and/or in connection with the localization device according to the present subject matter. In particular, the motor vehicle according to the present subject matter may have multiple laterally oriented radar devices, e.g., at least one such radar device on each side. The motor vehicle according to the present subject matter may have multiple such radar devices on at least one side, which may then have, for example, overlapping recording or detection regions. This can enable a monitoring, plausibility check or validation of measurement results and thus ultimately a particularly reliable detection or identification of lateral environment objects, in this case in particular artificial side barriers, and thus a particularly reliable and robust at least lateral localization or position determination of the motor vehicle.

Further features of the present subject matter may arise from the claims, the figures and the description of the figures. The features and combinations of features mentioned above in the description, as well as the features and combinations of features shown below in the description of the FIGURE and/or in the FIGURE alone, can be used not only in the combination specified in each case, but also in other combinations or on their own, without departing from the scope of the present subject matter.

### BRIEF DESCRIPTION OF THE DRAWING

FIG. 1 shows a partial schematic overview representation to illustrate a radar-based lateral localization of a motor vehicle according to the present subject matter.

### DETAILED DESCRIPTION OF THE DRAWING

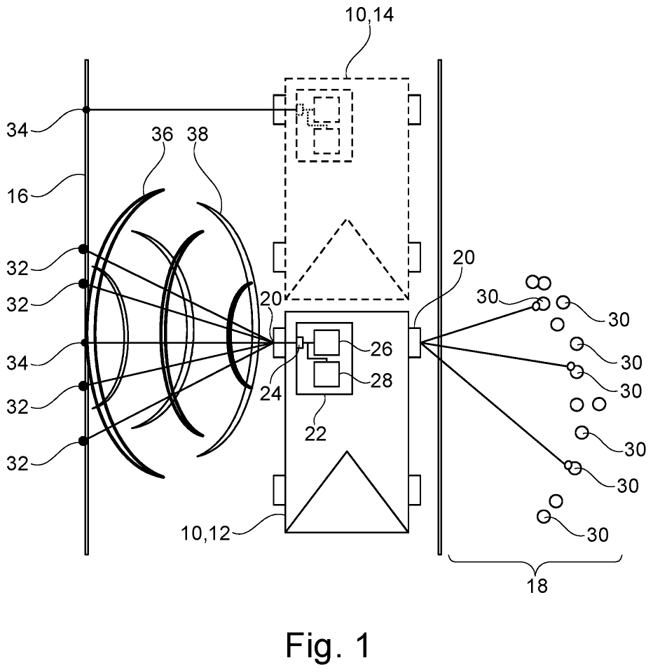

FIG. 1 shows a schematic partial overview to illustrate a method for radar-based—at least lateral—localization of a vehicle. For this purpose, a motor vehicle 10 is shown here, which is moving on a road. By way of illustration, the motor vehicle 10 is in a first position 12 here, which it occupies at a first point in time, and is indicated in a second position 14, which it occupies at a later second time. The road is bordered on one side by an artificial side barrier 16. On the other side of the road there is an embankment area 18 with unstructured, irregular, especially natural obstacles, such as vegetation.

In this case, the motor vehicle 10 has a lateral radar device 20 on both sides, each of which can detect or scan an area of the environment next to motor vehicle 10 in the transverse direction of the vehicle. The vehicle 10 also has a localization device 22, which is coupled to the radar device 20 via an interface 24. The localization device 22 has a processor 26 and a computer-readable data memory 28 coupled to it. This means that at least data supplied by the radar device 20 can be recorded and processed by the localization device 22 in order to carry out the method described here for localizing the motor vehicle 10.

The radar device 20 can periodically emit radar pulses while the motor vehicle 10 is in motion and receive corresponding reflections or radar echoes. On the basis of this, the radar device 20 itself and/or the localization device 22 can be used to determine a respective angle and distance, i.e., a respective position of a respective source of the radar echoes in an environment of the motor vehicle, in particular in a coordinate system fixed to the vehicle that moves along with the motor vehicle 10.

On the side of the embankment area 18, there is a large number of vegetation points 30, of which only a representative selection is explicitly marked here for the sake of clarity. The vegetation points 30 do not exhibit consistent, regular or stable repetitive characteristics, for example with regard to their position and/or velocity relative to the motor vehicle 10 or the corresponding radar device 20.

On the other side, there is a number of barrier points 32 that correspond to points or locations on the side barrier 16 from which radar echoes are received. In this case, the motor vehicle 10 moves parallel to the artificial side barrier 16, which extends along the road being travelled on. In such a situation, there is a labelled point on the artificial side barrier 16 at each position of the motor vehicle 10, which is marked here as a side point 34 for the first position 12 and for the second position 14 of the motor vehicle 10. A radar signal 36 emitted by the corresponding radar device 20 and indicated here schematically is incident on the artificial side barrier 16 at this side point 34. From the respective side point 34, a side echo 38, which is also schematically indicated here, is then reflected perpendicular to the motor vehicle 10 or the radar device 20 in a corresponding way. For the side points 34, this results in a perpendicular direction of incidence of the respective side echo 38 into the radar device 20 relative to the longitudinal direction of the vehicle or the direction of travel of the motor vehicle 10. In addition, the respective side echo 38 emanating or originating from the side point 34 indicates a relative velocity of the side point 34 relative to the motor vehicle 10 at least approximately of or close to 0 m/s, for example except for signal noise.

As indicated, such a side echo 38 occurs in each measurement cycle of the radar device 20, i.e., at each corresponding position of the motor vehicle 10 in the direction of travel. Accordingly, in each case, i.e. in this case at the first position 12 and at the second position 14, a side point 34 with a relative velocity of 0 m/s and a vertical direction of incidence of the corresponding side echo 38 is detected or determined at the same position or point relative to the motor vehicle 10, at least as long as the motor vehicle 10 is moving along the road parallel to the artificial side barrier 16.

An associated source of such stably repeating side echoes 38 or side points 34 is then identified as an artificial side barrier 16.

For reliable and robust identification of the artificial side barrier 16 or correspondingly reliable and robust determination of the side points 34, for example, a filter method can be used in which certain points in the vicinity of the motor vehicle 10 or particles corresponding to them generated in a model are filtered out, i.e. discarded, on the basis of the received radar echoes if deviating characteristics of the side points 34 or the associated side echoes 38 are determined and/or the points are not stably repeated over multiple measurement cycles of the radar device 20 at the same position or location relative to the motor vehicle 10. If necessary, changes in the properties or parameters of the side points 34 or the associated side echoes 38 that occur and are to be expected as a result of a lateral relative movement between the motor vehicle 10 and the artificial side barrier 16 can be taken into account, for example by adjusting a filter criterion accordingly.

For example, a predefined high-resolution or highly detailed map in which artificial side barriers are placed along roads, such as the artificial side barrier 16 partially shown here, can be placed in the data memory 28. This map can be compared with the position of the motor vehicle or the distance determined based on radar to the artificial barrier 16 identified as such based on radar in order to determine or monitor the current position of the motor vehicle 10 in the map.

Overall, the examples described show how the detection or classification of artificial side barriers can be realized during a journey of a vehicle using the in-vehicle side radar for the localization of the vehicle, in particular by using a particle filter. The term module (and other similar terms such as unit, subunit, submodule, etc.) in the present disclosure may refer to a software module, a hardware module, or a combination thereof. Modules implemented by software are stored in memory or non-transitory computer-readable medium. The software modules, which include computer instructions or computer code, stored in the memory or medium can run on a processor or circuitry (e.g., ASIC, PLA, DSP, FPGA, or other integrated circuit) capable of executing computer instructions or computer code. A hardware module may be implemented using one or more processors or circuitry. A processor or circuitry can be used to implement one or more hardware modules. Each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices and stored in memory or non-transitory computer readable medium.

### REFERENCE SIGN LIST

10 motor vehicle
12 first position
14 second position
16 artificial side barrier
18 embankment area
20 radar device
22 localization device
24 interface
26 processor
28 data memory
30 vegetation points
32 barrier points
34 side point
36 radar signal
38 side echo

1.-10. (canceled)

11. A method for localizing a motor vehicle, comprising:
providing a map in which artificial side barriers that run laterally along a road are entered;
emitting radar signals in a transverse direction of the vehicle during a journey using a radar device of the motor vehicle;
receiving resulting radar echoes;
determining the radar echoes which were reflected perpendicular to a longitudinal direction of the vehicle and/or perpendicular to the direction of travel of the motor vehicle and which indicate a vanishing relative velocity between the motor vehicle and a respective source from which the radar echo originates;
determining a distance of the motor vehicle from the respective source based on the radar echoes;
identifying the source of the radar echoes as an artificial side barrier; and
based on the identified source, determining a current position of the motor vehicle in the map.

12. The method according to claim 11, wherein
the source is identified as an artificial side barrier only if a corresponding radar echo is recorded from the same point in a fixed vehicle coordinate system over multiple measurement cycles of the radar device.

13. The method according to claim 11, further comprising:
determining an expected radar echo from the artificial side barrier based on the map and a respective current pose of the motor vehicle; and
monitoring the position of the motor vehicle on the map based on the expected radar echo and the determined radar echoes.

14. The method according to claim 11, further comprising:
generating a corresponding particle in a predetermined model for some or all of the received radar echoes, and then
using a predetermined particle filter to identify the radar echoes originating from the artificial side barrier.

15. The method according to claim 14, wherein
from measurement cycle to measurement cycle of the radar device, the particle filter retains only those particles that repeatedly occur at the same point in a coordinate system that is fixed relative to the vehicle and indicate a vanishing velocity of the respective source relative to the motor vehicle.

16. The method according to claim 11, further comprising:
modeling a change in a radar echo originating from an artificial side barrier during a lateral relative movement between the motor vehicle and the side barrier, and
assigning radar echoes over multiple measurement cycles of the radar device by considering the change in the radar echo.

17. The method according to claim 16, wherein
for determining the lateral relative movement, odometry data of the motor vehicle is automatically evaluated.

18. The method according to claim 16, wherein
for determining the lateral relative motion, a course of the road is determined and a course of the side barrier following this course of the road is modelled.

19. A localization device for a motor vehicle, comprising:
a data interface configured to acquire radar data,
a computer-readable data memory, and
a processor coupled to the memory, wherein
the localization device is configured to:
provide a map in which artificial side barriers that run laterally along a road are entered;
emit radar signals in the transverse direction of the vehicle during a journey using a radar device of the motor vehicle;
receive resulting radar echoes;
determine the radar echoes which were reflected perpendicular to the longitudinal direction of the vehicle and/or perpendicular to the direction of travel of the motor vehicle and which indicate a vanishing relative velocity between the motor vehicle and a respective source from which the radar echo originates;
determine a distance of the motor vehicle from the respective source based on the radar echoes;
identify the source of the radar echoes as an artificial side barrier; and
based on the identified source, determine the current position of the motor vehicle in the map.

20. A motor vehicle, comprising:
a radar device configured to detect environment objects to the side of the motor vehicle in the transverse direction of the vehicle, and
the localization device of claim 19 coupled to the radar device.
